(19) United States
(12) Patent Application Publication
(10) Pub. No.: US 2008/0244536 A1
(43) Pub. Date: Oct. 2, 2008

(54) EVALUATING STATIC ANALYSIS RESULTS USING CODE INSTRUMENTATION

(76) Inventors: Eitan Farchi, Pardes Hana (IL); Shay Gammer, Haifa (IL); Oma Raz-Pelleg, Haifa (IL); Shmuel Ur, Shorashim (IL)

Correspondence Address: IBM CORPORATION, T.J. WATSON RESEARCH CENTER, P.O. BOX 218, YORKTOWN HEIGHTS, NY, 10598, US

(21) Appl. No.: 11/691,506

(22) Filed: Mar. 27, 2007

(51) Int. Cl. G06F 9/44

(52) U.S. Cl. 717/130

(57) ABSTRACT

A computer-implemented method for evaluating software code includes receiving from a static analysis of the software code a warning indicating a respective location in the software code of a potential bug and a possible execution path leading to the potential bug. Responsively to the warning, instrumentation is added to the code at one or more locations along the execution path. Upon executing the instrumented code, an output is generated, responsively to the instrumentation, indicating that the execution path was traversed while executing the instrumented code.

### FIELD OF THE INVENTION

The present invention relates generally to computer systems and software, and specifically to detecting bugs in software code.

### BACKGROUND OF THE INVENTION

Static analysis tools analyze computer software code without actually executing programs built from that code. By contrast, dynamic analysis is performed on executing programs. Static analysis is usually faster than dynamic analysis and is capable of covering all possible program states. On the other hand, static analysis tools tend to have a high rate of false positive error reports, i.e., they output warnings of many potential bugs that do not actually have any deleterious effect at run time, typically because the program never actually reaches the corresponding error states.

Various attempts have been made to reduce the false positive rate of static analysis tools or to eliminate false positives by combining static and dynamic analysis techniques. A technique of this sort is described, for example, by Artho and Biere in “Combined Static and Dynamic Analysis” (Technical Report 466, Department of Computer Science, ETH Zürich, Switzerland, 2005). The authors explain that it is often desirable to retain information from static analysis for run-time verification, or to compare the results of both techniques. For this purpose, they developed a framework, which they call “JNuke,” for analysis of Java programs, in which static and dynamic analysis share the same generic algorithm and architecture.

As another example, Csallner and Smaragdakis describe an automatic error-detection approach that combines static checking and concrete test-case generation in “Check ‘n’ Crash: Combining Static Checking and Testing,” 27^{th} International Conference on Software Engineering (St. Louis, Mo., 2005). The authors state that their technique eliminates spurious warnings and improves the ease of comprehension of error reports.

### SUMMARY OF THE INVENTION

An embodiment of the present invention provides a computer-implemented method for evaluating software code. A static analysis of the software code provides a warning indicating a respective location in the software code of a potential bug and a possible execution path leading to the potential bug. Responsively to the warning, instrumentation is added to the code at one or more locations along the execution path. When the instrumented code is executed, the instrumentation causes an output to be generated, indicating that the execution path was traversed while executing the instrumented code. The code may then be debugged responsively to the output.

Other embodiments provide apparatus and computer software products for carrying out these functions.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for debugging software code, in accordance with an embodiment of the present invention; and

FIG. 2 is a block diagram that schematically illustrates a method for debugging software code, in accordance with an embodiment of the present invention.

### DETAILED DESCRIPTION OF EMBODIMENTS

Fixing bugs and making other modifications to existing code often introduces new bugs. This problem of bug creation is especially acute when modifications are made to legacy code, which is often complex and not fully understood by those who are currently responsible for its maintenance. Debugging legacy code can itself be time consuming and expensive, and changes may often require authorization by external reviewers.

Although static analysis tools can be useful in identifying potential problems in modified legacy code, the high false-positive rate of these tools may complicate the task of debugging still further, by requiring programmers to work through long lists of potential bugs in the code that never actually occur during execution. In response to this problem, programmers often reduce the sensitivity of their static analysis tools (which commonly offer this sort of adjustment capability), which may consequently cause the tools to miss true bugs that fall below the sensitivity threshold. For all these reasons, it is desirable to filter out false positives and minimize the number of potential bugs that programmers must try to fix, while permitting the programmers to use high sensitivity in their static analysis.

Embodiments of the present invention use code instrumentation (i.e., special-purpose instructions that are added to software code), based on the results of static analysis, in order to determine which potential bugs actually do occur during execution. The instrumentation is added at certain points along possible execution paths that the static analysis has identified as leading to the potential bugs. When the code is then executed, the instrumentation generates an output that reveals which of these potential bugs actually do occur during normal operation of the code. Consequently, at least some of the remaining bug warnings from the static analysis may be ignored. Filtering out the false positives in this manner permits programmers to operate the static analysis tool at higher sensitivity, and thus to detect and fix more true bugs without otherwise modifying the static analysis tool in any way.

The techniques that are described hereinbelow are useful particularly in debugging legacy code, which is usually executable and often has a test suite that is representative of its use. This existing test suite may be used to exercise the code in ways that are representative of operation under actual application conditions. Alternatively, the techniques described herein may similarly be applied in debugging of new programs that have a execution environment suitable for these purposes.

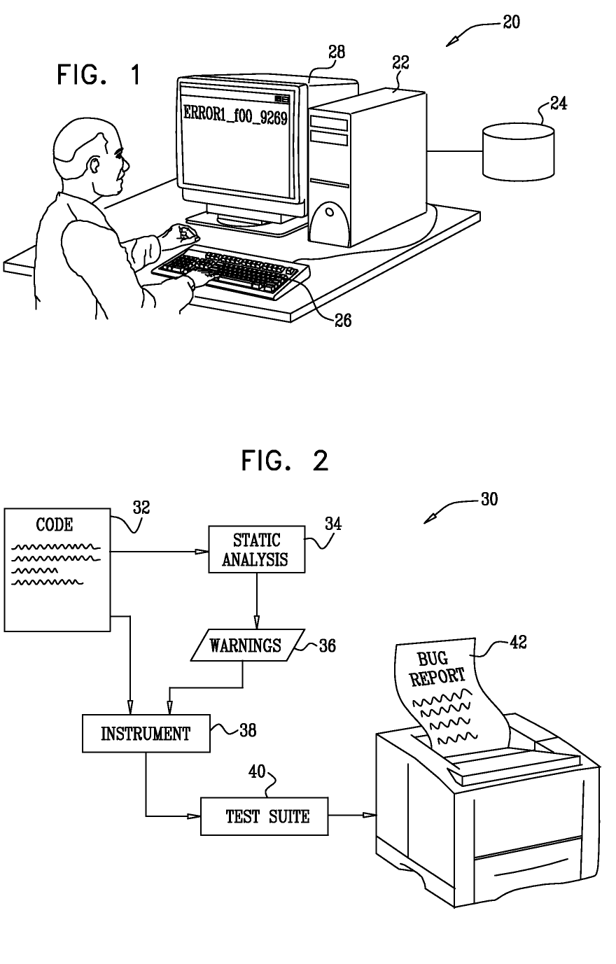

FIG. 1 is a schematic, pictorial illustration of a system 20 for debugging software code, in accordance with an embodiment of the present invention. System 20 comprises a code processor 22, which is operated by a programmer to analyze and debug software code, which is typically stored in a memory 24. The programmer interacts with processor 22 via a user interface, which typically comprises an input device 26, such as a keyboard and/or mouse, and an output device 28, such as a display monitor and/or printer.

Processor 22 performs a static analysis of the software code and instruments the code, as described hereinbelow, based on the results of the analysis. The processor then compiles and executes the code, possibly using a test suite that has been prepared for testing code operation. When the code traverses a path to a potential bug that was instrumented following static analysis, the instrumentation causes processor 22 to output an indication that the path was traversed, and thus to show the programmer that an actual bug exists in the program. The output may be delivered to the programmer via output device 28 and/or recorded in memory 24. Typically, the programmer responds to this indication by debugging the code. Alternatively or additionally, processor 22 may automatically suggest or implement a code correction.

Typically, processor 22 comprises a general-purpose computer, which is programmed in software to carry out the functions described herein. The software may be downloaded to the computer in electronic form, via a network, for example, or it may alternatively be provided on tangible media, such as optical, magnetic, or electronic memory. Processor 22 may comprise a single computer, as illustrated in FIG. 1, or it may comprise a group of two or more computers, with the various functions divided up among them.

FIG. 2 is a block diagram that schematically illustrates a method 30 for debugging software code 32, in accordance with an embodiment of the present invention. Code 32 is typically provided in the form of source code, although the principles of the present invention may also be applied, mutatis mutandis, in debugging of object code. Processor 22 applies a static analyzer 34 to the code in order to detect potential bugs. Many static analysis tools are known in the art, and some of them not only identify potential bugs in the code, but also indicate possible execution paths through the code that lead to the bugs.

One tool of this sort, which has been used by the inventors in developing the present embodiment, is BEAM, which is described, for example, by Brand in “A Software Falsifier,” International Symposium on Software Reliability Engineering (San Jose, Calif., 2000). BEAM is a static analysis tool that looks for bugs in C, C++, and Java software. Like other such tools, the problems BEAM reports include bad memory accesses (uninitialized variables, dereferencing null pointers, etc.) memory leaks, and unnecessary computations, for example. It analyzes the likelihood that suspected errors are actually bugs and filters out suspected errors whose likelihood is below a certain sensitivity threshold, which may be set by the user. (As noted earlier, use of code instrumentation as described herein permits the user to set the threshold to a lower value, i.e., to increase the sensitivity and hence the number of true bugs discovered by the static analysis tool.) Alternatively, other tools with similar capabilities may be used.

Upon discovering a potential bug, BEAM issues a warning 36 reporting the type and location of the bug and identifying a possible execution path leading to the bug. Deciding feasibility of paths, however, is a computationally hard problem and cannot take into account all run-time conditions. Therefore, as noted earlier, many of warnings 36 issued by BEAM (and other static analyzers) are false positives, in the sense that normal execution of code 32 never actually traverses the paths leading to these bugs, or that the potential bug in question cannot actually occur for other reasons not known to the static analysis tool.

Operation of static analyzer 34 is illustrated below with reference to the following sample routine, written in C:

TABLE I
SAMPLE CODE BEFORE INSTRUMENTATION

bug.c content:
line 1: int *p;
line 2:
line 3: void
line 4: foo(int a)
line 5: {
line 6: int b, c;
line 7:
line 8: b = 0;
line 9: if(!p)
line 10: c = 1;
line 11: SOME_MACRO( )
line 12:
line 13: if(c > a)
line 14: c += p[1];
line 15: }

Upon analyzing this code, BEAM returns the following error type 1 (ERROR1) warning, indicating an uninitialized variable (in this case, the variable ‘c’):
—ERROR1 /*uninitialized*/ >>>ERROR1_foo_{—}9269b7a63
“bug.c”, line 12: uninitialized ‘c’

### ONE POSSIBLE PATH LEADING TO THE ERROR:

“bug.c”, line 6: allocating ‘c’

“bug.c”, line 9: the if-condition is false

“bug.c”, line 13: getting the value of ‘c’

Processor 22 reviews warnings 36 and, where appropriate, automatically adds instrumentation 38 to code 32 along the paths indicated by the warnings. For example, when the processor encounters a warning regarding an uninitialized variable (ERROR1), the processor may execute the following logic in order to decide where and how to instrument the code:
1. Get error name-identifier—ID—from first line of warning (for example, ERROR1_foo_{—}9269b7a63);
2. Locate line of allocation—A—in the path given by the warning;
3. Get variable type—T—and suspected uninitialized variable name—U—from A;
4. Locate line of get-value—B—in the path given by the warning;
5. Add copy_U of type T and initialize it to U immediately after A (line A+1): T copy_U=U;
6. Add a check for the value of U immediately before B (line B−1): if (U==copy_U) {printf(“Error1_%s: Path taken\n”, ID)}.
   When processor 22 subsequently executes the instrumented code, the printf( ) statement will output an error message only if the execution has traversed the path indicated by warning 36.

Application of the above logic to the sample code in Table I will give the following instrumented code:

TABLE II
INSTRUMENTED CODE

bug.c content:
line 1: int *p;
line 2:
line 3: void
line 4: foo(int a)
line 5: {
line 6: int b, c;
line 7: int copy_c = c;
line 8: b = 0;
line 9: if(!p)
line 10: c = 1;
line 11: SOME_MACRO( )
line 12: if (c == copy_c) { printf(“ERROR1_foo_9269b7a63:
Path taken\n”);
line 13: if (c > a)
line 14: c += p[1];
line 15: }

Instrumentation 38 has added a declaration of a new variable ‘copy_c’ at line 7 and assigned to it the value of the suspected uninitialized variable ‘c’ immediate after the allocation (line 6). An instruction is also added at line 12 to test the value of the suspected uninitialized variable against the new variable immediately before getting the value of the suspected uninitialized variable (line 13).

Processor 22 executes the instrumented code, possibly using an existing test suite 40 to provide a representative set of input commands and data. With respect to the sample code in Table I, if the execution traverses the path through lines 6 and 13 that was indicated by the static analysis bug warning and instrumented as shown in Table II, the added instruction at lines 7 and 12 will cause the processor to issue a bug report 42. Thus, the programmer will know that this particular warning refers to an actual bug, which should be fixed. Alternatively, if the instrumentation of this particular bug warning does not result in a bug report upon execution, the programmer will know that this warning is in all likelihood a false positive, and that the potential bug that it indicates need not be corrected. Eliminating unneeded code changes not only saves time for the programmer, but also avoids additional bugs that often appear when code is changed (particularly in legacy code).

Processor 22 may similarly instrument code 32 in response to warnings of other types. For example, BEAM ERROR4 warns of accessing an already-deallocated flag, which may occur when the code contains multiple pointers to an address, one of which is accessed after another is freed. In this case, processor 22 may instrument the code on the given path so that when the first pointer is freed, the range of freed addresses is recorded, and a Boolean flag is initialized to true. When a subsequent pointer is accessed, a second instrumentation instruction checks whether the address of the pointer is within the recorded range, and whether the Boolean flag is set to true. If both conditions are met, the processor issues a bug report.

As yet another example, BEAM ERROR9 warns of passing NULL, i.e., passing a non-existent address. To investigate this sort of error, processor 22 adds instrumentation just before the end of the execution path, to check the contents of the pointer in question before passing it. Possible instrumentation for other types of static analysis warnings will be apparent to those skilled in the art and is considered to be within the scope of the present invention.

Although the above examples refer to certain types of errors in C code that are discovered by BEAM, the principles of the present invention may similarly be applied to other error types, as well as in debugging code in other languages, using a variety of static analysis tools that are known in the art. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A computer-implemented method for evaluating software code, comprising:
receiving from a static analysis of the software code a warning indicating a respective location in the software code of a potential bug and a possible execution path leading to the potential bug;
responsively to the warning, adding instrumentation to the code at one or more locations along the execution path;
executing the instrumented code;
responsively to the instrumentation, generating an output indicating that the execution path was traversed while executing the instrumented code; and
responsively to the output, debugging the code.

2. The method according to claim 1, wherein the warning is indicative of a suspected uninitialized variable, and wherein adding the instrumentation comprises testing a value of the suspected uninitialized variable at a point along the execution path.

3. The method according to claim 1, wherein the warning is indicative of at least one type of bug selected from a group of types consisting of accessing a deallocated flag and passing a non-existent address.

4. The method according to claim 1, wherein adding the instrumentation comprises automatically adding instructions to the code at multiple locations along the execution path.

5. The method according to claim 1, wherein generating the output comprises determining, if the output was not generated while executing the instrumented code, that the warning is a false positive.

6. The method according to claim 1, wherein executing the instrumented code comprises applying a test suite to provide inputs that are representative of an actual application of the software code.

7. The method according to claim 6, wherein receiving the warning comprises performing the static analysis on legacy software code after making a change in the code, and wherein applying the test suite comprises using an existing test suite that was used with the legacy software code before the change was made.

8. Apparatus for evaluating software code, comprising:
a memory, which is arranged to stored the software code; and
a code processor, which is arranged to receive from a static analysis of the software code a warning indicating a respective location in the software code of a potential bug and a possible execution path leading to the potential bug, and to add, responsively to the warning, instrumentation to the code at one or more locations along the execution path, so as to generate upon execution of the instrumented code, an output responsive to the instrumentation, which indicates that the execution path was traversed while executing the instrumented code.

9. The apparatus according to claim 8, wherein the warning is indicative of a suspected uninitialized variable, and wherein the instrumentation tests a value of the suspected uninitialized variable at a point along the execution path.

10. The apparatus according to claim 8, wherein the warning is indicative of at least one type of bug selected from a group of types consisting of accessing a deallocated flag and passing a non-existent address.

11. The apparatus according to claim 8, wherein the code processor is arranged to instrument the code by adding instructions to the code at multiple locations along the execution path.

12. The apparatus according to claim 8, wherein the code processor is arranged to add the instrumentation so as to indicate that the warning is a false positive if the output is not generated while executing the instrumented code.

13. The apparatus according to claim 8, wherein the code processor is arranged to execute the instrumented code by applying a test suite to provide inputs that are representative of an actual application of the software code.

14. The apparatus according to claim 13, wherein the code processor is arranged to perform the static analysis on legacy software code after a programmer has made a change in the code, and to execute the instrumented code using an existing test suite that was used with the legacy software code before the change was made.

15. A computer software product for evaluating software code, the product comprising a computer-readable medium in which program instructions are stored, which instructions, when read by a computer, cause the computer to receive from a static analysis of the software code a warning indicating a respective location in the software code of a potential bug and a possible execution path leading to the potential bug, and to add, responsively to the warning, instrumentation to the code at one or more locations along the execution path, so as to generate upon execution of the instrumented code, an output responsive to the instrumentation, which indicates that the execution path was traversed while executing the instrumented code.

16. The product according to claim 15, wherein the warning is indicative of a suspected uninitialized variable, and wherein the instrumentation tests a value of the suspected uninitialized variable at a point along the execution path.

17. The product according to claim 15, wherein the warning is indicative of at least one type of bug selected from a group of types consisting of accessing a deallocated flag and passing a non-existent address.

18. The product according to claim 15, wherein the instructions cause the computer to instrument the code by adding instructions to the code at multiple locations along the execution path.

19. The product according to claim 15, wherein the instructions cause the computer to add the instrumentation so as to indicate that the warning is a false positive if the output is not generated while executing the instrumented code.

20. The product according to claim 15, wherein the instructions cause the computer to execute the instrumented code by applying a test suite to provide inputs that are representative of an actual application of the software code.
